(19) United States
(12) Patent Application Publication
(10) Pub. No.: US 2018/0275972 A1
(43) Pub. Date: Sep. 27, 2018

(54) INFORMATION PROCESSING APPARATUS

(71) Applicant: Konica Minolta, Inc., Tokyo (JP)

(72) Inventor: Ichiro Bessho, Okazaki-shi (JP)

(21) Appl. No.: 15/926,268

(22) Filed: Mar. 20, 2018

(30) Foreign Application Priority Data
Mar. 22, 2017 (JP) 2017-055797

(51) Int. Cl. G06F 8/38; G06F 8/34; G06F 11/30; H04N 1/00

(52) U.S. Cl. CPC G06F 8/38; G06F 8/34; H04N 1/00408; H04N 1/00079; G06F 11/30

(57) ABSTRACT

An information processing apparatus includes: an image processing device; a server connected to the image processing device; and an operation display shared by the image processing device and the server, wherein each of the image processing device and the server includes: a display memory that stores display data displayed on the operation display; a drawing controller that performs control for displaying the display data; and a state information transmitter that is capable of transmitting state information indicating a state of a host device to the other device, the information processing apparatus further includes a switching controller that switches connection between the operation display and the drawing controller, a display screen includes at least one specific area for displaying the state information, and the drawing controller displays the display data and changes the display data such that the state information is displayed in the specific area.

The entire disclosure of Japanese patent Application No. 2017-055797, filed on Mar. 22, 2017, is incorporated herein by reference in its entirety.

### BACKGROUND

### Technological Field

The present invention relates to an information processing apparatus including a server and an image processing device, such as a multi-function peripheral (MFP) that is a multi-function digital image forming device, which can operate independently.

### Description of the Related art

In addition to the MFP that mainly uses paper media, an information processing device, such as a server using electronic data, is generally used in an office. In addition, both the MFP and the information processing device are generally used to perform multiple processes.

Therefore, it is considered that a plurality of devices which operate independently, such as an MFP and an information processing device, are accommodated in one housing to provide one information processing apparatus in order to, for example, simplify the operation or management of all devices in the office.

In this case, since the devices in the information processing apparatus can originally operate independently, the devices may independently include operation displays such as operation panels that display various kinds of display data including an operation screen and are operated by the user.

However, in this case, a plurality of operation displays are provided in one information processing apparatus and user convenience is likely to be reduced. In addition, since the operation displays are exposed to the outside, a space for installing the operation displays increases, which makes the integration of a plurality of devices into one information processing apparatus meaningless.

For this reason, it is considered that one operation display is provided so as to be shared by the devices and the operation display is used while being switched to the server and the image processing device if necessary.

In addition, JP 2014-241494 A discloses an information processing system that can reduce the number of application development processes using the functions of a main apparatus. An MFP is provided with a manufacturer application with which an error screen is associated in advance and a vendor application with which the error screen is not associated. The MFP includes a display, an abnormality detector, a drawer, and a controller. The display displays a screen of a display target application. The abnormality detector detects an error that occurs in the MFP. In a case where an error is detected, the drawer draws an error screen indicating the detected error on a screen of the manufacturer application. In a case where an error is detected while the vendor application is operating, the controller performs a control process which switches a display target application from the vendor application to the manufacturer application and displays the error screen.

However, in the structure in which one operation display is used while being switched to the server and the image processing device, in some cases, the screen of the image processing device is desired to be instantly displayed during the control of the screen by the server. For example, when the user performs an operation such that the operation screen of the server is displayed on the operation display and operates the server, the user wants to rapidly display the screen of the image processing device in the following cases: a case where the image processing device receives a print job or a facsimile (FAX) job from an external device; a case where the state of the image processing device is changed, such as a case where the image processing device is changed to a sleep mode which is an energy saving mode; and a case where paper jam, trouble, toner empty, and paper empty occur.

On the contrary, in some cases, the screen of the server is desired to be instantly displayed during the control of the screen by the image processing device. For example, when the operation screen of the image processing device is displayed on the operation display and the image processing device is operated, the user wants to instantly display the screen of the server in a case where an error occurs in the hardware of the server or a network connection error occurs.

In this case, it is considered that the connection of the operation display is switched from the server to the image processing device or from the image processing device to the server to switch the entire screen of the operation display to the screen of the image processing device or the server, in order to instantly inform the user of the state of the image processing device or the server. However, the user that wants to continuously operate the server or the image processing device while monitoring the screen of the server or the image processing device has a problem that the screen is switched to the screen of the image processing device or the server during the operation, which causes operational inconvenience.

The technique disclosed in JP 2014-241494 A is a technique in which one device, such as an MFP, performs processes and is not a technique related to one information processing apparatus including a plurality of devices that operate independently. Therefore, JP 2014-241494 A does not provide a solution to the problem of the related art in which operational inconvenience caused by the switching of the screen occurs in a case where one operation display is shared in the information processing apparatus.

### SUMMARY

The invention has been made in view of the above-mentioned technical background, and an object of the invention is to provide an information processing apparatus that includes an image processing device, a server, and an operation display shared by the image processing device and the server. In a case where a screen of one of the image processing device and the server is displayed on the operation display and there is a change in the state of the other device, the information processing apparatus enables a user to recognize the state of the other device, without switching the displayed screen to the screen of the other device.

To achieve the abovementioned object, according to an aspect of the present invention, an information processing apparatus reflecting one aspect of the present invention comprises: an image processing device; a server that is connected to the image processing device; and an operation display that is shared by the image processing device and the server, wherein each of the image processing device and the server includes: a display memory that stores display data displayed on the operation display; a drawing controller that performs control for displaying the display data stored in the display memory on the operation display; and a state information transmitter that is capable of transmitting state information indicating a state of a host device to the other device, the information processing apparatus further includes a switching controller that switches connection between the operation display and the drawing controller of the image processing device or the server, a display screen that is displayed on the operation display on the basis of the display data of one of the image processing device and the server includes at least one specific area for displaying the state information, and the drawing controller of one of the image processing device and the server displays the display data stored in the display memory of the host device on the operation display in a case where the drawing controller is connected to the operation display and changes the display data such that the state information is displayed in the specific area while being connected to the operation display in a case where the state information is acquired from the other device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating the configuration of an information processing apparatus according to an embodiment of the invention;

FIG. 2 is a diagram illustrating a server function menu screen which is an initial screen;

FIG. 3 is a diagram illustrating another example of the server function menu screen;

FIG. 4 is a diagram illustrating a function menu screen of an image processing device displayed in a case where an MFP/server screen switching button is pressed in the server function menu screen illustrated in FIG. 2 or FIG. 3;

FIG. 5 is a diagram illustrating a copy setting screen;

FIG. 6 is a diagram illustrating another example of the copy setting screen;

FIG. 7 is a flowchart illustrating the basic operation of the information processing apparatus;

FIGS. 8A and 8B are flowcharts illustrating a subroutine of initial setting control in step S101 of the flowchart illustrated in FIG. 7, FIG. 8A is a flowchart illustrating a process of a server, and FIG. 8B is a flowchart illustrating a process of the image processing device;

FIG. 9 is a diagram illustrating an aspect of coordinate data of a specific area and a data format notification of which is provided from a drawing controller of the server to a drawing controller of the image processing device and a response to the coordinate data and the data format from the drawing controller of the image processing device;

FIG. 10 is a diagram illustrating an aspect of state information requested to be transmitted notification of which is provided from the drawing controller of the server to the drawing controller of the image processing device and a response to the state information from the drawing controller of the image processing device;

FIG. 11 is a diagram illustrating an aspect of coordinate data of a specific area and a data format notification of which is provided from the drawing controller of the image processing device to the drawing controller of the server and a response to the coordinate data and the data format from the drawing controller of the server;

FIG. 12 is a diagram illustrating an aspect of state information requested to be transmitted notification of which is provided from the drawing controller of the image processing device to the drawing controller of the server and a response to the state information from the drawing controller of the server;

FIG. 13 is a sequence diagram illustrating the operation of each drawing controller until the state information transmitted from the image processing device is displayed in the specific area of the server after notification of the coordinate data, the data format, and the state information is provided from the drawing controller of the server to the drawing controller of the image processing device;

FIG. 14 is a sequence diagram illustrating the operation of each drawing controller until the state information transmitted from the server is displayed in the specific area of the image processing device after notification of the coordinate data, the data format, and the state information is provided from the drawing controller of the image processing device to the drawing controller of the server;

FIG. 15 is a flowchart illustrating the operation of the information processing apparatus in a case where the state information of the opponent device related to the function that is being performed is preferentially displayed in the specific area;

FIG. 16 is a sequence diagram illustrating the operation of each drawing controller until the state information, which is related to the function that is being performed and has been transmitted from the image processing device, is displayed in the specific area of the server after notification of the coordinate data, the data format, and the state information is provided from the drawing controller of the server to the drawing controller of the image processing device in a case where the information processing apparatus performs the operation illustrated in FIG. 15;

FIG. 17 is a sequence diagram illustrating the operation of each drawing controller until the state information, which is related to the function that is being performed and has been transmitted from the server, is displayed in the specific area of the image processing device after notification of the coordinate data, the data format, and the state information is provided from the drawing controller of the image processing device to the drawing controller of the server in a case where the information processing apparatus performs the operation illustrated in FIG. 15;

FIG. 18 is a diagram illustrating an aspect of another example of the state information requested to be transmitted notification of which is provided from the drawing controller of the server to the drawing controller of the image processing device and a response to the state information from the drawing controller of the image processing device;

FIG. 19 is a diagram illustrating an aspect of another example of the state information requested to be transmitted notification of which is provided from the drawing controller of the image processing device to the drawing controller of the server and a response to the state information from the drawing controller of the server;

FIG. 20 is a sequence diagram illustrating the operation of each drawing controller until the state information transmitted from the image processing device is displayed in the specific area of the server after notification of the coordinate data, the data format, and the state information is provided from the drawing controller of the server to the drawing controller of the image processing device in a case where priority is set to the state information;

FIG. 21 is a sequence diagram illustrating the operation of each drawing controller until the state information transmitted from the server is displayed in the specific area of the image processing device after notification of the coordinate data, the data format, and the state information is provided from the drawing controller of the image processing device to the drawing controller of the server in a case where priority is set to the state information; and

FIG. 22 is a diagram illustrating an example of display in a case where it is necessary to display a plurality of state information items in the specific area.

### DETAILED DESCRIPTION OF EMBODIMENTS

Hereinafter, one or more embodiments of the present invention will be described with reference to the drawings. However, the scope of the invention is not limited to the disclosed embodiments.

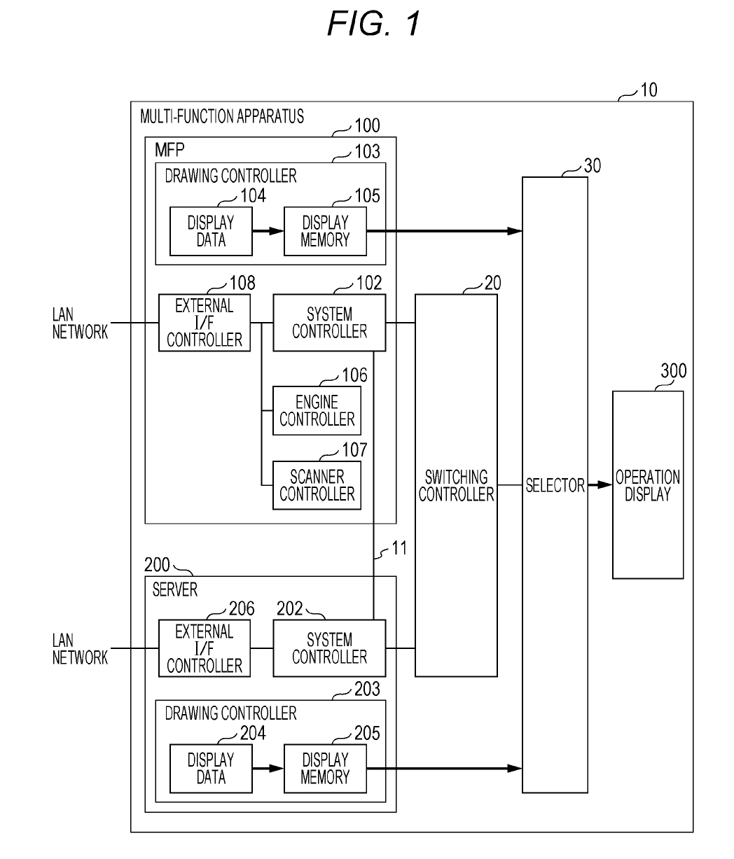

FIG. 1 is a block diagram illustrating the configuration of an information processing apparatus 10 according to an embodiment of the invention. In this embodiment, an image processing device 100 that is an MFP and operates independently and a server 200 that is, for example, a PC and operates independently are accommodated in one housing to form the information processing apparatus 10. In the following description, the image processing device is also referred to as an MFP. The MFP 100 and the server 200 may not be necessarily accommodated in one housing. The MFP 100 and the server 200 may be provided in the information processing apparatus 10 so as to be adjacent to each other.

The information processing apparatus 10 includes the MFP 100, the server 200 connected to the MFP 100, and one operation display 300 that is shared by the two devices.

The MFP 100 operates independently and includes, for example, a system controller 102, a drawing controller 103, and a storage (not illustrated). The system controller 102 controls the overall operation of the MFP 100 and includes, for example, a CPU, a ROM, and a RAM which are not illustrated. In a case where display data of the MFP 100 is desired to be displayed on the operation display 300, the system controller 102 issues a connection request to a switching controller 20, which will be described below.

In addition, for example, an engine controller 106, a scanner controller 107, and an external interface (I/F) controller 108 are connected to the system controller 102. The engine controller 106 controls an engine that forms an image and the scanner controller 107 controls a scanner that reads a document. The engine controller 106 and the scanner controller 107 receive the user's operation and perform functions, such as a copy function, a printer function, and a scanning function under the control of the system controller 102. The external interface controller 108 performs control for connecting a network, such as a LAN, and the MFP 100 in response to a command from the system controller 102.

The drawing controller 103 includes a display memory 105 that is called a VRAM storing display data 104. The drawing controller 103 transmits display data stored in the display memory 105 to the operation display 300 such that the display data is displayed or combines a plurality of display parts, such as operation buttons and messages of the host device, to generate the display data 104, stores the display data 104 in the display memory 105, and performs, for example, a process of updating content in the display memory 105 if necessary.

The server 200 also operates independently and includes a system controller 202 and a drawing controller 203. The system controller 202 controls the overall operation of the server 200 and includes, for example, a CPU, a ROM, and a RAM which are not illustrated. For example, a process of receiving the user's operation and a process corresponding to the received operation are performed under the control of the system controller 202. In addition, in a case where display data of the server 200 is desired to be displayed on the operation display 300, the system controller 202 issues a connection request to the switching controller 20, which will be described below.

The drawing controller 203 includes a display memory 205 that stores display data 204. The drawing controller 203 transmits display data stored in the display memory 205 to the operation display 300 such that the display data is displayed or combines a plurality of display parts, such as operation buttons and messages of the host device, to generate the display data 204, stores the display data 204 in the display memory 205, and performs, for example, a process of updating content in the display memory 205 if necessary.

The server 200 includes, for example, a storage device, such as a hard disk device, and an external interface controller 206, in addition to the system controller 202 and the drawing controller 203. The external interface controller 206 performs control for connecting a network, such as a LAN, and the server 200 in response to a command from the system controller 202.

The operation display 300 is a display device, such as a liquid crystal display device, and has a touch panel stacked on a surface. Therefore, in a case where the user touches a screen, touch information indicating the coordinates of a touch position is transmitted to the MFP 100 or the server 200 and the MFP 100 or the server 200 performs a process corresponding to the coordinate data of the touch position or transmits the display data stored in the display memory 105 or 205 to the operation display 300 such that the display data is displayed.

In this embodiment, since one operation display 300 is shared by the MFP 100 and the server 200, the information processing apparatus 10 includes a selector 30 and the switching controller 20.

The selector 30 switches connection between the operation display 300 and each of the drawing controllers 103 and 203 of the MFP 100 and the server 200. That is, in a case where the selector 30 performs switching to the connection between the operation display 300 and the drawing controller 103 of the MFP 100, the display data 104 stored in the display memory 105 of the MFP 100 is transmitted to the operation display 300 through the selector 30 and is then displayed. In a case where the user performs an operation for an operation screen of the MFP 100 displayed on the operation display 300, touch information is transmitted from the operation display 300 to the MFP 100. In a case where the selector 30 performs switching to the connection between the drawing controller 203 of the server 200 and the operation display 300, the display data 204 stored in the display memory 205 of the server 200 is transmitted to the operation display 300 through the selector 30 and is then displayed. In a case where the user performs an operation for an operation screen of the server 200 displayed on the operation display 300, touch information is transmitted from the operation display 300 to the server 200.

The switching controller 20 receives the connection request issued from each of the system controllers 102 and 202 of the MFP 100 and the server 200 and controls the switching of connection by the selector 30. That is, in a case where the system controller 102 of the MFP 100 issues the connection request, the switching controller 20 controls the selector 30 such that the drawing controller 103 of the MFP 100 is connected to the operation display 300. In a case where the system controller 202 of the server 200 issues the connection request, the switching controller 20 controls the selector 30 such that the drawing controller 203 of the server 200 is connected to the operation display 300.

As such, in this embodiment, the operation display 300 is shared by the MFP 100 and the server 200. Therefore, one operation display 300 is enough and the number of operation displays 300 is less than that in a case where each device includes the operation display 300. In addition, operability is high and a space for installing the operation display 300 is reduced. Therefore, it is possible to reduce the size of the information processing apparatus 10.

The system controllers 102 and 202 of the MFP 100 and the server 200 are connected through the communication unit 11 such that they can communicate with each other and can transmit and receive display data or various kinds of information. Therefore, even in a case where the selector 30 is switched to the MFP 100 and the display data of the MFP 100 is displayed on the operation display 300, the drawing controller 103 of the MFP 100 can display the display data transmitted from the server 200 through the communication unit 11 on the screen of the operation display 300. On the contrary, even in a case where the selector 30 is switched to the server 200 and the display data of the server 200 is displayed on the operation display 300, the drawing controller 203 of the server 200 can display the display data transmitted from the MFP 100 through the communication unit 11 on the screen of the operation display 300.

The communication unit 11 may be, for example, a USB interface or a network.

Next, the screen displayed on the operation display 300 will be described.

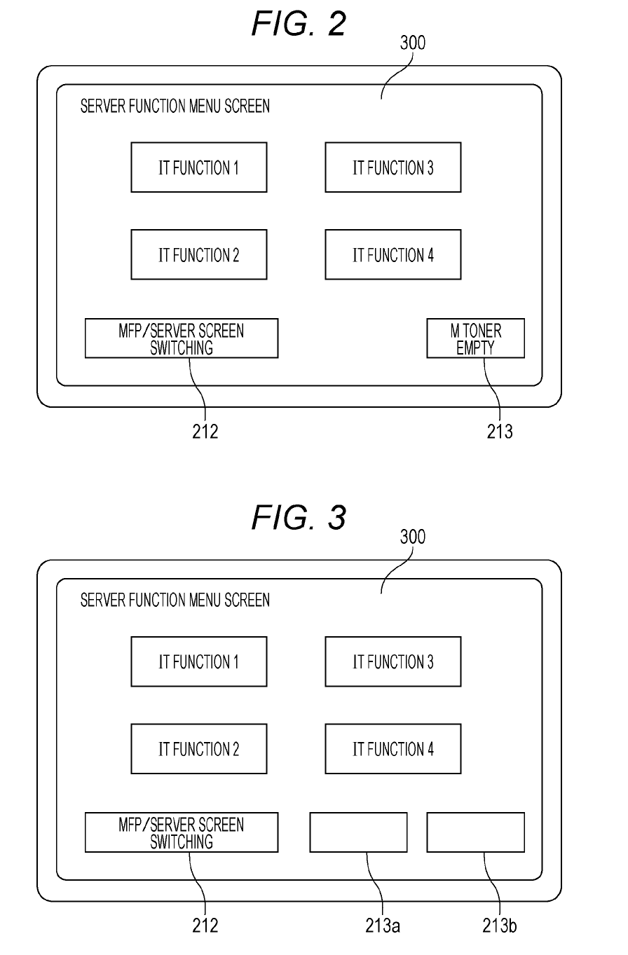

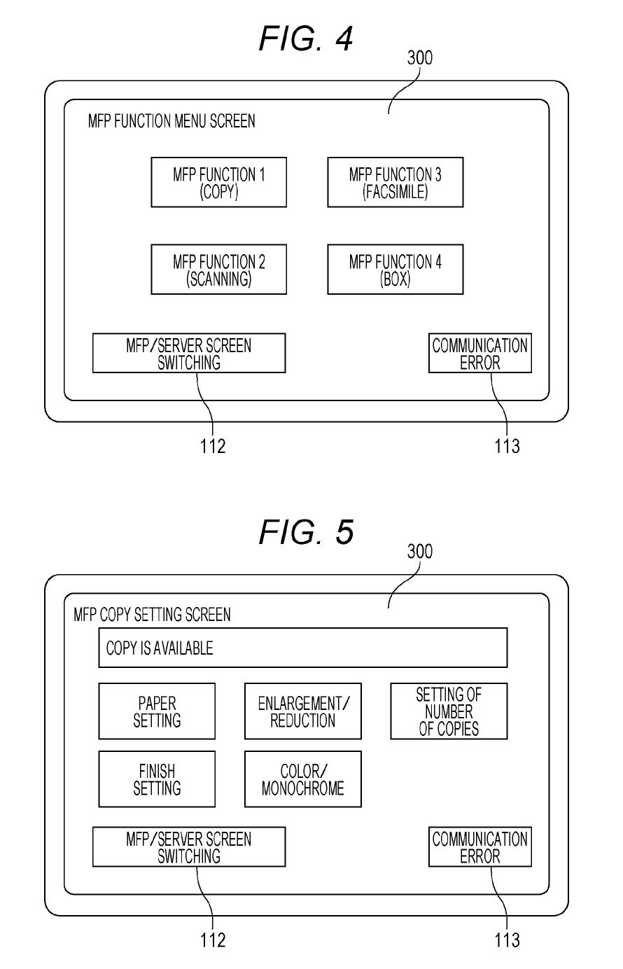

In this embodiment, in a state in which the information processing apparatus 10 is not used (in an initial state), the switching controller 20 performs a setting process such that the drawing controller 203 of the server 200 is connected to the operation display 300 and a server function menu screen illustrated in FIG. 2 is displayed as an initial screen on the operation display 300. Function buttons, such as “IT function 1”, “IT function 2”, “IT function 3”, and “IT function 4”, for using the functions of the server 200, and an “MFP/server screen switching” button 212 are displayed on the server function menu screen. The “MFP/sewer screen switching” button 212 is used to change the screen to an MFP function menu screen illustrated in FIG. 4 and is always displayed on the operation display 300 when the screen of the server 200 including the server function menu screen is displayed. Therefore, during the operation of the server 200, the user can press the “MFP/server screen switching” button 212 to change the screen to the MFP function menu screen and can use the function of the MFP 100 at any time.

In this embodiment, in a case where the screen of the server 200 including the server function menu screen illustrated in FIG. 2 is displayed, a specific area 213 is included in a portion of the screen and state information indicating the state of the MFP 100 can be displayed in the specific area 213 if necessary. In the example illustrated in FIG. 2, information indicating that magenta (M) toner is empty in the MFP 100 is displayed. One specific area 213 may be provided as illustrated in FIG. 2, two specific areas 213a and 213b may be provided as illustrated in FIG. 3, or three or more specific areas may be provided.

In a case where the user selects any one of the IT function buttons on the server function menu screen illustrated in FIGS. 2 and 3, performs various settings, performs the function, and ends the use of the function, the drawing controller 203 generates the display data of the server function menu screen which is the initial screen illustrated in FIG. 2 and the server function menu screen is displayed on the operation display 300. In this case, since the operation display 300 has been connected to the drawing controller 203 of the server 200, the switching of connection by the selector 30 is not performed.

In a case where the user presses the “MFP/server screen switching” button 212 on the server function menu screen, the system controller 202 of the server 200 notifies the system controller 102 of the MFP 100 that the button 212 has been pressed. The drawing controller 103 of the MFP 100 generates the display data of the MFP function menu screen illustrated in FIG. 4 on the basis of the notification and stores the display data in the display memory 105. In a case where the system controller 102 of the MFP 100 issues a connection request to the switching controller 20, the switching controller 20 receives the request and switches the selector 30 such that the drawing controller 103 of the MFP 100 is connected to the operation display 300. The drawing controller 103 of the MFP 100 displays the generated MFP function menu screen illustrated in FIG. 4 on the operation display 300.

The following are displayed on the MFP function menu screen: function buttons, such as “MFP function 1 (copy)”, “MFP function 2 (scanning)”, “MFP function 3 (facsimile)”, and “MFP function 4 (box)” for using a copy function, a scanning function, a facsimile function, and a box function of the MFP 100; and an “MFP/server screen switching” button 112. The “MFP/server screen switching” button 112 is used to change the screen to the server function menu screen illustrated in FIG. 2 or FIG. 3 and is always displayed when the screen of the MFP 100 is displayed on the operation display 300. Therefore, during the operation of the MFP 100, the user can press the “MFP/server screen switching” button 112 to change the screen to the server function menu screen and can use the functions of the server 200 at any time. The box function uses a storage region which is called a box. For example, the box function stores a scanned document in the box or transmits a document stored in the box to the outside.

The user can touch any one of the function buttons to use each function of the MFP 100. When the user presses, for example, the “MFP function 1 (copy)” button, the screen of the operation display 300 is changed to an MFP copy setting screen illustrated in FIG. 5.

For example, a message “copy is available”, setting buttons, such as “paper setting”, “enlargement/reduction”, “setting of the number of copies”, “finish setting”, and “color/monochrome”, and the “MFP/server screen switching” button 112 are displayed on the MFP copy setting screen.

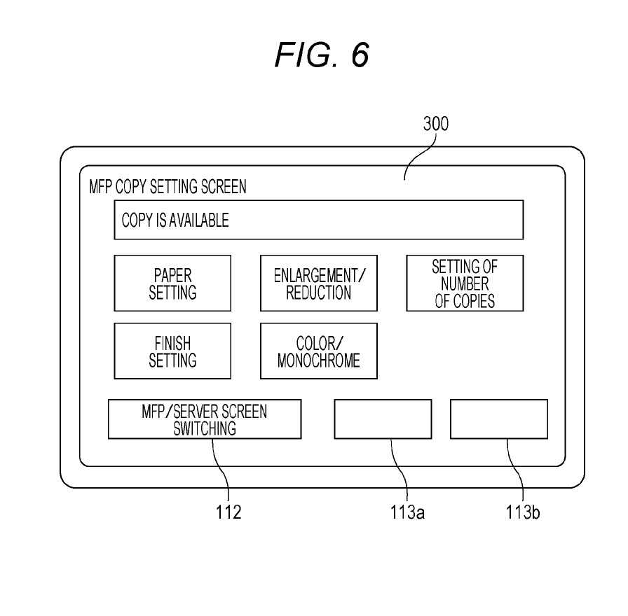

In this embodiment, in a case where the screen of the MFP 100 including the MFP function menu screen illustrated in FIG. 4 or the MFP copy setting screen illustrated in FIG. 5 is displayed on the operation display 300, a specific area 113 is included in a portion of the screen and state information indicating the state of the server 200 can be displayed in the specific area 113. In the example illustrated in FIG. 5, information indicating that a communication error has occurred in the server 200 is displayed. One specific area 113 may be provided as illustrated in FIGS. 4 and 5, two specific areas 113a and 113b may be provided as illustrated in FIG. 6, or three or more specific areas may be provided.

When the user performs various settings on the MFP copy setting screen illustrated in FIG. 5 and presses a start button (not illustrated), the MFP 100 performs a copy process. After the copy process is completed, the information processing apparatus 10 returns to a state in which it is not used. That is, the system controller 102 of the MFP 100 notifies the system controller 202 of the server 200 that the operation has been completed. Then, the drawing controller 203 of the server 200 generates the display data of the server function menu screen which is the initial screen and stores the display data in the display memory 205. The switching controller 20 operates the selector 30 such that the drawing controller 203 of the server 200 is connected to the operation display 300 and the drawing controller 203 of the server 200 displays the server function menu screen illustrated in FIG. 2 on the operation display 300.

As such, in a case where, with the screen of one of the MFP 100 and the server 200 displayed on the operation display 300, the state of the other device changes, the state information of the other device is displayed in the specific area 113 (113a and 113b) or 213 (213a and 213b) which is a portion of the screen. Therefore, the user can recognize a change in the state of the other device from the state information displayed in the specific area, without switching the displayed screen to the screen of the other device, and can take necessary measures. As a result, it is possible to improve operability.

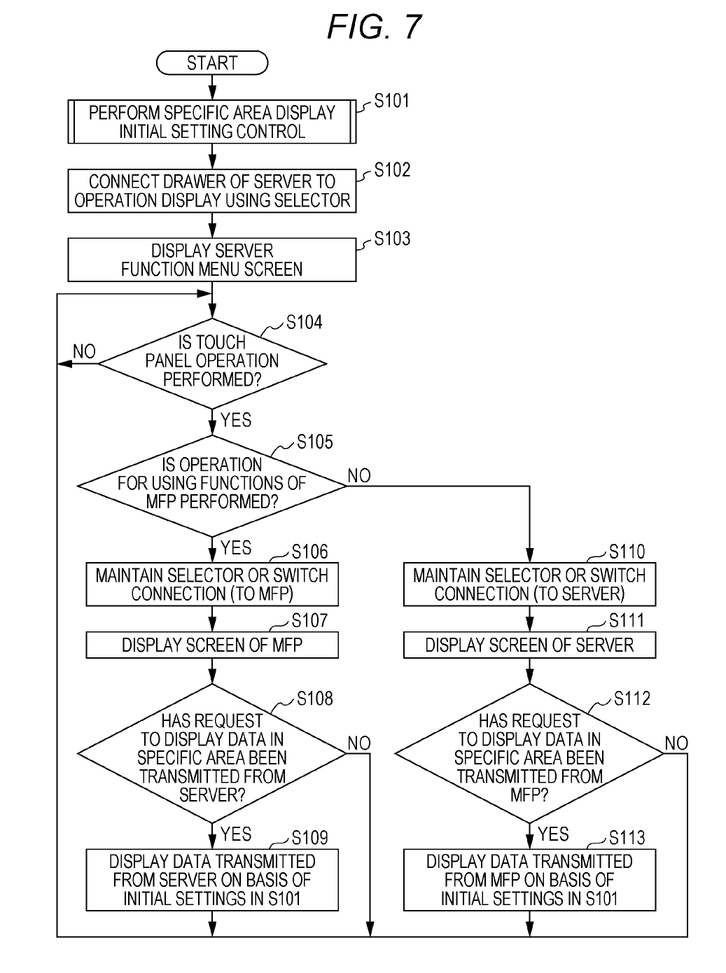

FIG. 7 is a flowchart illustrating the basic operation of the information processing apparatus 10.

When the information processing apparatus 10 is turned on, in step S101, each of the system controllers 102 and 202 of the MFP 100 and the server 200 performs initial setting control for displaying the state information of the opponent device in the specific area 113 (113a and 113b) or 213 (213a and 213b).

Specifically, for example, each of the drawing controllers 103 and 203 of the MFP 100 and the server 200 notifies the opponent device of the coordinate data of the specific area 113 (113a and 113b) or 213 (213a and 213b) in which the state information of the opponent device is displayed, the data format of state information, and state information requested to be transmitted in the display data of the screen that is created by each device and is then displayed on the operation display 300, under the control of the system controllers 102 and 202, and the drawing controller and the opponent device have common recognition. That is, for example, the server 200 notifies the MFP 100 of the coordinate data of the specific area 213 (213a and 213b), a data format, and the state information of the MFP 100 requested to be transmitted. For example, the MFP 100 notifies the server 200 of the coordinate data of the specific area 113 (113a and 113b), a data format, and the state information of the server 200 requested to be transmitted. The initial setting control will be described below.

In step S102, the switching controller 20 switches the selector 30 to the server 200 such that the drawing controller 203 of the server 200 is connected to the operation display 300, according to default settings. In step S103, the server function menu screen illustrated in FIG. 2 which is the display data that has been generated by the drawing controller 203 of the server 200 and then stored in the display memory 205 is displayed on the operation display 300. Then, in step S104, it is determined whether a touch panel operation has been performed for the operation display 300. In a case where the touch panel operation has not been performed (NO in step S104), the system controller 202 waits until a touch panel operation is performed. In a case where the touch panel operation has been performed (YES in step S104), in step S105, it is determined whether the touch panel operation is an operation for selecting the MFP/server screen switching button 212 to use the MFP 100. In a case where the touch panel operation is the operation for using the functions of the MFP 100 (YES in step S105), in step S106, the drawing controller 203 of the server 200 notifies the system controller 102 of the MFP 100 that an operation for using the MFP 100 has been performed. In a case where the MFP 100 receives the notification, the drawing controller 103 generates the display data of the MFP function menu screen and the system controller 102 issues a connection request to the switching controller 20.

When receiving the connection request, the switching controller 20 switches the selector 30 such that the drawing controller 103 of the MFP 100 is connected to the operation display 300 in step S106. In step S107, the drawing controller 103 of the MFP 100 displays the generated MFP function menu screen on the operation display 300.

In step S108, the system controller 101 of the MFP 100 determines whether a request to display data in the specific area 113 (113a and 113b) on the screen has been transmitted from the server 200. In a case where the request has not been transmitted (NO in step S108), the system controller 101 returns to step S104 and determines whether the next operation has been performed for the touch panel. In a case where the request to display data in the specific area 113 (113a and 113b) has been transmitted (YES in step S108), in step S109, the drawing controller 103 of the MFP 100 displays the display data of the state information transmitted from the server 200 in the specific area 113 (113a and 113b) on the basis of the initial settings obtained in step S101 and returns to step S104.

In a case where the touch panel operation is not the operation for using the functions of the MFP 100 in step S105 (NO in step S105), since the touch panel operation is an operation for using the functions of the server 200, the switching controller 20 maintains the connection between the operation display 300 and the drawing controller 203 of the server 200 by the selector 30 in step S110. In step S111, the drawing controller 203 of the server 200 displays the generated next display data on the operation display 300.

In step S112, the system controller 201 of the server 200 determines whether a request to display data in the specific area 213 (213a and 213b) on the screen has been transmitted from the MFP 100. In a case where the request has not been transmitted (NO in step S112), the system controller 201 returns to step S104 and determines whether the next operation has been performed for the touch panel. In a case where the request to display data in the specific area 213 (213a and 213b) has been transmitted (YES in step S112), in step S113, the drawing controller 203 of the server 200 displays the display data of the state information transmitted from the MFP 100 in the specific area 213 (213a and 213b) on the basis of the initial settings obtained in step S101 and returns to step S104.

Then, whenever a touch panel operation is performed in step S104, it is determined in step S105 whether the touch panel operation is an operation for using the functions of the MFP 100. The connection between the operation display 300 and each of the drawing controllers 103 and 203 by the selector 30 is switched or maintained on the basis of the determination result and the current connection state between the operation display 300 and each of the drawing controllers 103 and 203.

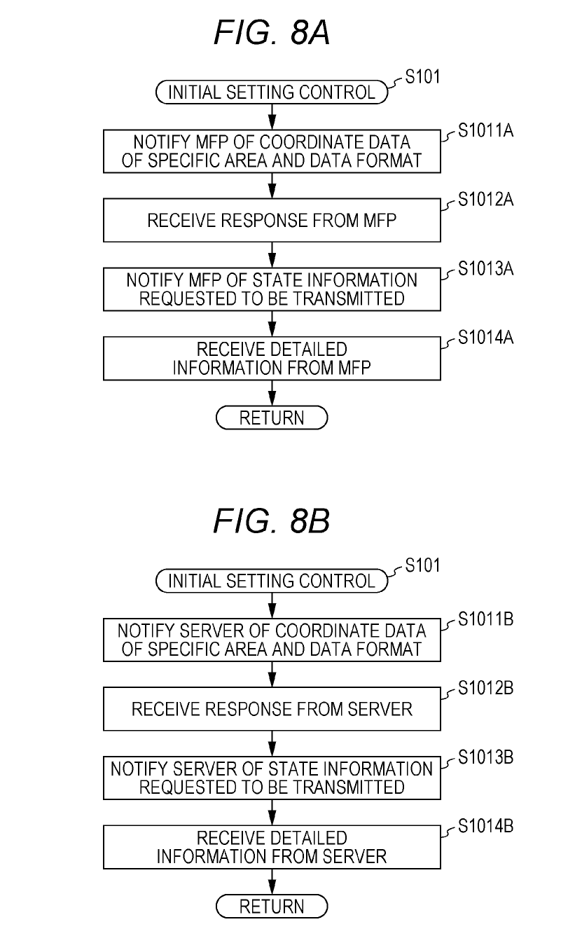

FIGS. 8A and 8B are flowcharts illustrating the subroutine of the initial setting control in step S101 of the flowchart illustrated in FIG. 7. FIG. 8A is a flowchart illustrating the process of the server 200 and FIG. 8B is a flowchart illustrating the process of the MFP 100.

In step S1011A of FIG. 8A, the drawing controller 203 of the server 200 notifies the drawing controller 103 of the MFP 100 of coordinate data indicating the specific area 213 (213a and 213b) and the data format of the state information displayed in the specific area 213 (213a and 213b) through the communication unit 11.

In step S1012A, the drawing controller 203 receives a response indicating that the coordinate data and data format notification of which was provided have been recognized from the MFP 100.

Then, in step S1013A, the drawing controller 203 provides notification of the state information of the MFP 100 requested to be transmitted through the communication unit 11.

In step S1014A, the drawing controller 203 receives the detailed information of the MFP 100 as a response to the state information notification of which is provided and returns to the flowchart illustrated in FIG. 7.

The server 200 may collectively notify the MFP 100 of the coordinate data, the data format, and the state information requested to be transmitted.

In step S1011B of FIG. 8B, the drawing controller 103 of the MFP 100 notifies the drawing controller 203 of the server 200 of coordinate data indicating the position of the specific area 113 (113a and 113b) and the data format of the state information displayed in the specific area 113 (113a and 113b) through the communication unit 11.

In step S1012B, the drawing controller 103 receives a response indicating that the coordinate data and data format notification of which was provided have been recognized from the server 200.

Then, in step S1013B, the drawing controller 103 provides notification of the state information of the server 200 requested to be transmitted through the communication unit 11.

In step S1014B, the drawing controller 103 receives the detailed information of the server 200 as a response to the state information notification of which is provided and returns to the flowchart illustrated in FIG. 7.

The MFP 100 may collectively notify the server 200 of the coordinate data, the data format, and the state information requested to be transmitted.

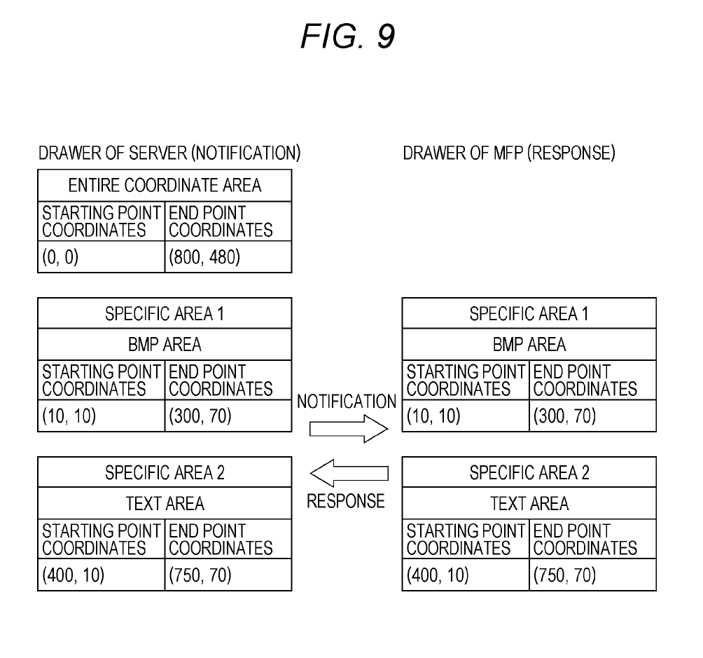

FIG. 9 illustrates an aspect of the coordinate data of the specific area and the data format of the state information notification of which is provided from the drawing controller 203 of the server 200 to the drawing controller 103 of the MFP 100 and a response to the coordinate data and the data format from the drawing controller 103 of the MFP 100.

In this example, the entire coordinate area of the display data (display screen) of the server 200 has starting point coordinates (0, 0) and end point coordinates (800, 480) and two specific areas, that is, specific area 1 and specific area 2 are set as the specific area in which the state information of the server 200 is displayed. The specific area 1 has starting point coordinates (10, 10) and end point coordinates (300, 70) and the format of the display data displayed in the specific area is bitmap data (BMP). The specific area 2 has starting point coordinates (400, 10) and end point coordinates (750, 70) and the format of the display data is text data.

As illustrated in FIG. 9, the server 200 notifies the MFP 100 of the coordinate data of each of the specific areas 1 and 2 and the data format of the state information displayed in the specific areas. When recognizing the coordinate data and data format notification of which is provided, the MFP 100 transmits a response indicating that the coordinate data and the data format have been recognized to the server 200.

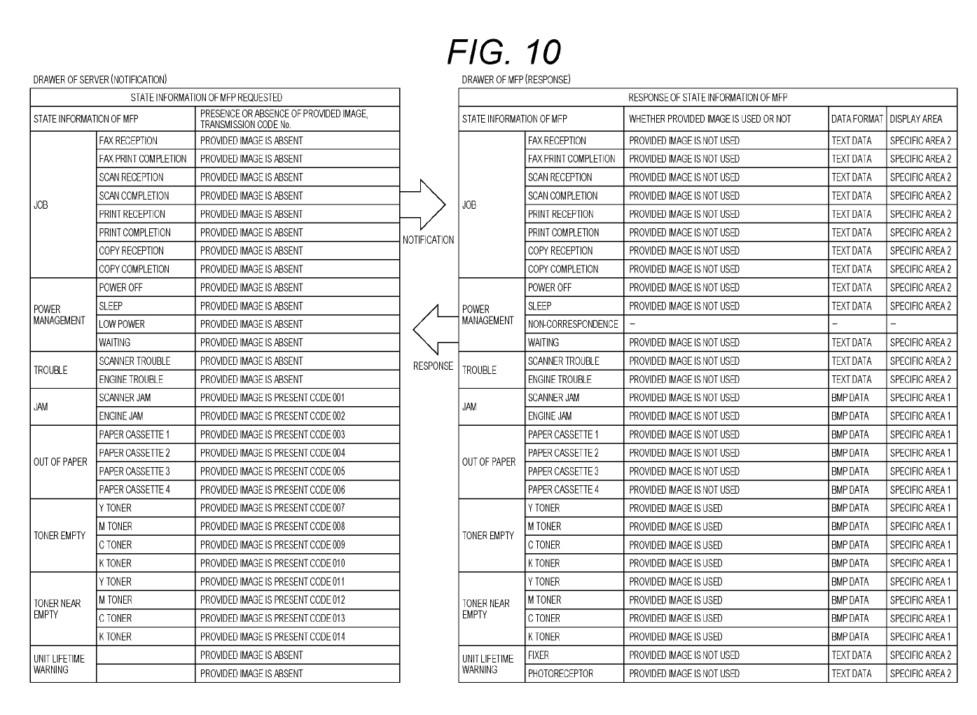

FIG. 10 illustrates an aspect of the state information requested to be transmitted notification of which is provided from the drawing controller 203 of the server 200 to the drawing controller 103 of the MFP 100 and a response to the state information from the drawing controller 103 of the MFP 100.

The state information of the MFP 100 requested to be transmitted notification of which is provided from the drawing controller 203 of the server 200 to the drawing controller 103 of the MFP 100 is classified into, for example, a job (JOB), power management (power transition state), trouble, paper jam (JAM), out of paper, toner empty, toner near empty, and unit lifetime warning. Examples of the job include state information items, such as FAX reception, FAX print completion, scanning reception, scanning completion, print reception, print completion, copy reception, and copy completion. Examples of the power management include state information items, such as power OFF, sleep, low power, and waiting. Examples of the trouble include state information items such as scanner trouble and engine trouble.

In some cases, for the state information of the MFP 100 requested to be transmitted, display data (image) is provided in the server 200 in advance. The server 200 notifies the MFP 100 of information indicating whether a provided image is present or absent and a transmission code number set in the image in a case where the provided image is present. Then, it is checked whether the provided image is used.

When receiving notification of the state information, the drawing controller 103 of the MFP 100 transmits information indicating whether each classification of the job (JOB), power management (power transition state), trouble, paper jam (JAM), out of paper, toner empty, toner near empty, and unit lifetime warning notification of which is provided, corresponds to the state information as a response to the server 200. In the table illustrated in FIG. 10, state information (for example, “low power” in power management) described as “non-correspondence” indicates that there is no corresponding state information in the MFP 100.

In addition to the response indicating whether each classification corresponds to the state information, information indicating whether the image provided in the server 200 is used, the data format of the state information, and information indicating which of the specific areas 1 and 2 the state information is displayed are transmitted as a response for each state information item. When receiving the response, the server 200 stores the content of the response in a storage (not illustrated).

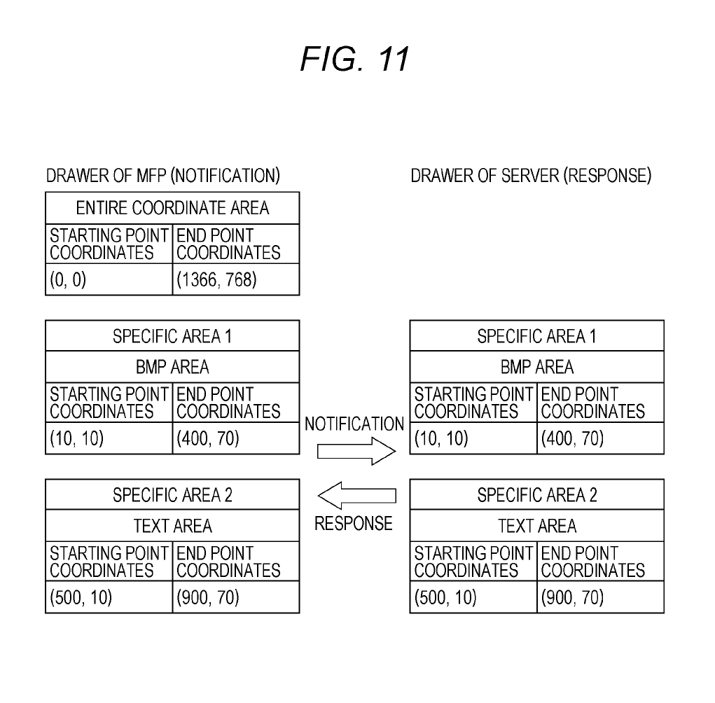

FIG. 11 illustrates an aspect of the coordinate data of the specific area and the data format of the state information notification of which is provided from the drawing controller 103 of the MFP 100 to the drawing controller 203 of the server 200 and a response to the coordinate data and the data format from the drawing controller 203 of the server 200.

In this example, the entire coordinate area of the display data (display screen) of the MFP 100 has starting point coordinates (0, 0) and end point coordinates (1366, 768) and two specific areas, that is, specific area 1 and specific area 2 in which the state information of the server 200 is displayed are set. The specific area 1 has starting point coordinates (10, 10) and end point coordinates (400, 70) and the data format of the state information displayed in the specific area is bitmap data (BMP). The specific area 2 has starting point coordinates (500, 10) and end point coordinates (900, 70) and the data format is text data.

As illustrated in FIG. 11, the MFP 100 notifies the server 200 of the coordinate data of each of the specific areas 1 and 2 and the data format of the state information displayed in the specific areas. When recognizing the coordinate data and data format notification of which is provided, the server 200 transmits a response indicating that the coordinate data and the data format have been recognized to the MFP 100.

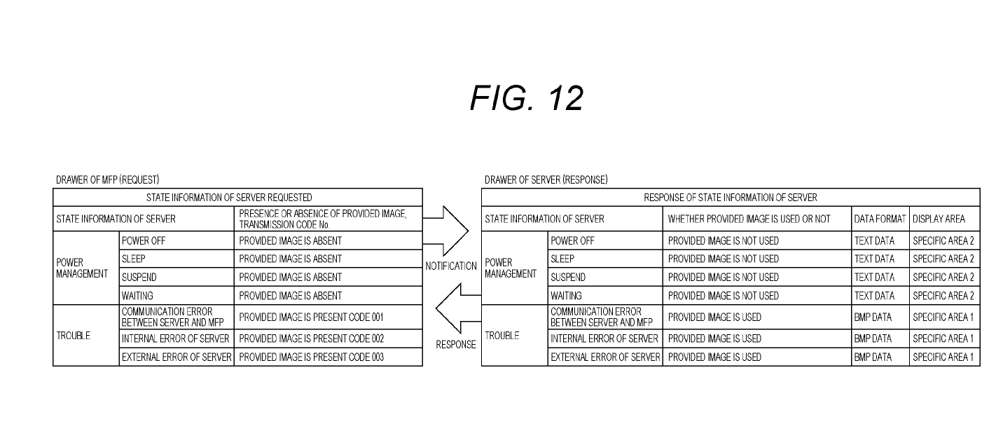

FIG. 12 illustrates an aspect of the state information requested to be transmitted notification of which is provided from the drawing controller 103 of the MFP 100 to the drawing controller 203 of the server 200 and a response to the state information from the drawing controller 203 of the server 200.

The state information of the server 200 requested to be transmitted notification of which is provided from the drawing controller 103 of the MFP 100 to the drawing controller 203 of the server 200 is classified into, for example, power management (power transition state) and trouble. The power management includes state information items, such as power OFF, sleep, suspend, and waiting. The trouble includes state information items, such as a communication error between the server and MFP, an internal error, and an external error.

In some cases, for the state information of the server 200 requested to be transmitted, display data (image) is provided in the MFP 100 in advance. The MFP 100 notifies the server 200 of information indicating whether a provided image is present or absent and a transmission code number set in the image in a case where a provided image is present. Then, it is checked whether the provided image is used.

When receiving notification of the state information, the drawing controller 203 of the server 200 transmits information indicating whether each classification of the power management (power transition state) and trouble notification of which is provided corresponds to the state information as a response to the MFP 100. In addition to the response indicating whether each classification corresponds to the state information, information indicating whether the image provided in the MFP 100 is used, the data format of the state information, and information indicating which of the specific areas 1 and 2 the state information is displayed are transmitted as a response for each state information item. When receiving the response, the MFP 100 stores the content of the response in a storage (not illustrated).

As such, the drawing controller 103 or 203 of one of the MFP 100 and the server 200 notifies the other device of the coordinate data of the specific area 113 (113a and 113b) or 213 (213a and 213b), the data format of the state information required for display, and the state information requested to be transmitted in advance. The other device transmits its own state information to the one device on the basis of these information items. Therefore, it is possible to accurately display the state information of the other device in the specific area.

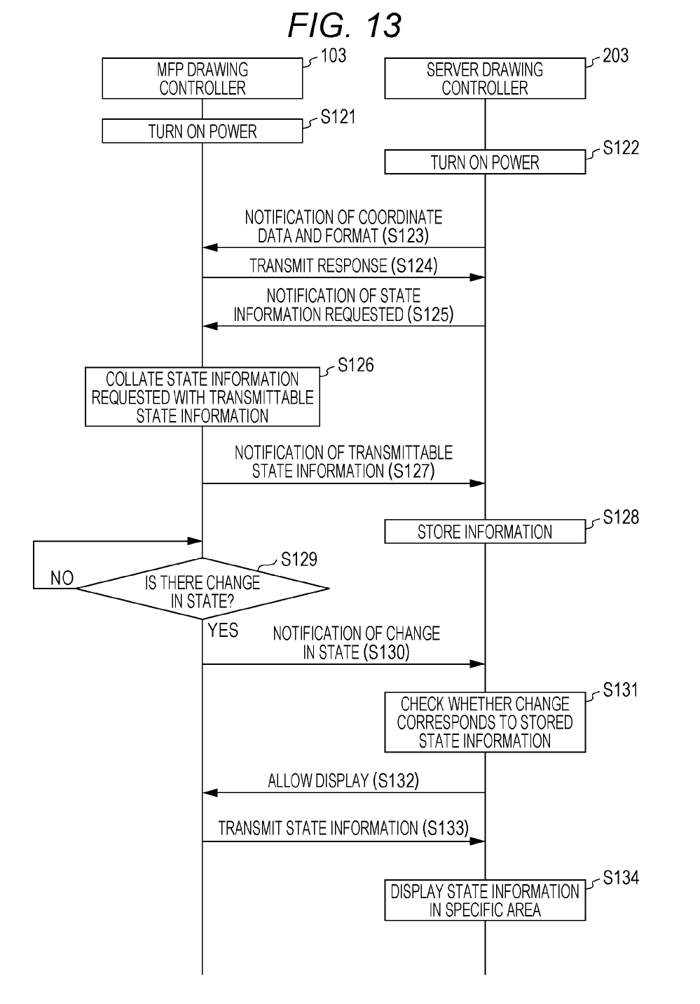

FIG. 13 is a sequence diagram illustrating the operation of each of the drawing controllers 203 and 103 until the state information transmitted from the MFP 100 is displayed in the specific area 213 (213a and 213b) of the server 200 after notification of the coordinate data, the data format, and the state information requested to be transmitted is provided from the drawing controller 203 of the server 200 to the drawing controller 103 of the MFP 100.

When the MFP 100 and the server 200 are turned on in steps S121 and S122, the drawing controller 203 of the server 200 extracts the coordinate data of the specific area 213 (213a and 213b) associated with the initial screen of the server 200 and the data format of the state information displayed in the specific area 213 (213a and 213b) and notifies the drawing controller 103 of the MFP 100 of the extracted information (step S123). When recognizing the received coordinate data and data format, the drawing controller 103 of the MFP 100 transmits a response indicating that the coordinate data and the data format have been recognized (step S124).

Then, the drawing controller 203 of the server 200 notifies the drawing controller 103 of the MFP 100 of the state information of the MFP 100 requested to be transmitted (step S125).

When receiving the state information, the drawing controller 103 of the MFP 100 detects the state information stored therein from the entire state information requested to be transmitted and checks whether the state information can be transmitted (step S126). Then, the drawing controller 103 notifies the drawing controller 203 of the server 200 of the transmittable state information in addition to information such as information indicating whether the provided image is used, the data format, and the specific area in which the state information is displayed (step S127). The drawing controller 203 of the server 200 stores the received information in the storage (step S128).

Then, the drawing controller 103 of the MFP 100 monitors whether there is a change in the state of the host device through the system controller 102 (step S129). In a case where there is a change in the state (YES in step S129), the drawing controller 103 notifies the drawing controller 203 of the server 200 that there is a change in the state and requests the display of the state information (step S130).

The drawing controller 203 of the server 200 checks whether the change in the state is a change in state related to the state information which has been transmitted as the transmittable state information from the MFP 100 in advance and then stored in the storage (step S131). In a case where the changes in the state correspond to each other, the drawing controller 203 notifies the drawing controller 103 of the MFP 100 that display has been allowed (step S132).

When receiving the display allowance notification, the drawing controller 103 of the MFP 100 transmits the corresponding state information to the drawing controller 203 of the server 200 (step S133). In a case where the image of the state information provided in the server 200 is used, the drawing controller 103 transmits a transmission code of the image as the state information. The drawing controller 203 of the server 200 displays the received state information in the specific area 213 (213a and 213b) (step S134).

The process from step S129 to step S134 is performed when the screen of the server 200 is displayed on the operation display 300 and corresponds to step S112 and step S113 in FIG. 7.

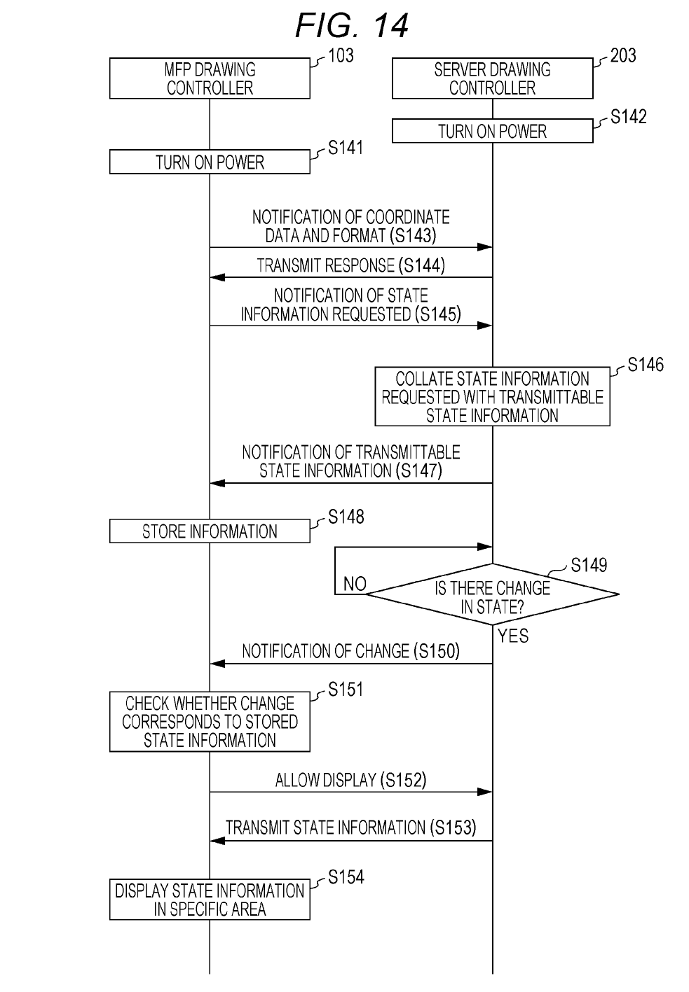

FIG. 14 is a sequence diagram illustrating the operation of each of the drawing controllers 103 and 203 until the state information transmitted from the server 200 is displayed in the specific area 113 (113a and 113b) of the MFP 100 after notification of coordinate data, a data format, and the state information requested to be transmitted is provided from the drawing controller 103 of the MFP 100 to the drawing controller 203 of the server 200.

When the MFP 100 and the server 200 are turned on in step S141 and step S142, the drawing controller 103 of the MFP 100 extracts the coordinate data of the specific area 113 (113a and 113b) associated with the initial screen of the MFP 100 and the data format of the state information displayed in the specific area 113 (113a and 113b) and notifies the drawing controller 203 of the server 200 of the extracted information (step S143). When recognizing the received coordinate data and data format, the drawing controller 203 of the server 200 transmits a response indicating that the coordinate data and the data format have been recognized (step S144).

Then, the drawing controller 103 of the MFP 100 notifies the drawing controller 203 of the server 200 of the state information of the server 200 requested to be transmitted (step S145).

When receiving the state information, the drawing controller 203 of the server 200 detects the state information stored therein from the entire state information requested to be transmitted and checks whether the state information can be transmitted (step S146). Then, the drawing controller 203 notifies the drawing controller 103 of the MFP 100 of the transmittable state information in addition to information such as information indicating whether the provided image is used, the data format, and the specific area in which the state information is displayed (step S147). The drawing controller 103 of the MFP 100 stores the received information in the storage (step S148).

Then, the drawing controller 203 of the server 200 monitors whether there is a change in the state of the host device through the system controller 202 (step S149). In a case where there is a change in the state (YES in step S149), the drawing controller 203 notifies the drawing controller 103 of the MFP 100 that there is a change in the state (step S150).

The drawing controller 103 of the MFP 100 checks whether the change in the state is a change in state related to the state information which has been transmitted as the transmittable state information from the server 200 in advance and then stored in the storage (step S151). In a case where the changes in the state correspond to each other, the drawing controller 103 notifies the drawing controller 203 of the server 200 that display has been allowed (step S152).

When receiving the display allowance notification, the drawing controller 203 of the server 200 transmits the corresponding state information to the drawing controller 103 of the MFP 100 (step S153). The drawing controller 103 of the MFP 100 displays the received state information in the specific area 113 (113a and 113b) (step S154).

The process from step S149 to step S154 is performed when the screen of the MFP 100 is displayed on the operation display 300 and corresponds to step S108 and step S109 in FIG. 7.

However, it is preferable that the state information of one of the MFP 100 and the server 200 which is displayed in the specific area of the other device have an effect on the process performed by the user in terms of operation.

For example, the server 200 has a function that directs the MFP 100 to perform scanning with a scanner, receives scan data from the MFP 100, performs a character recognition process and a file format conversion process for the received scan data if necessary, and uploads the scan data to an external transmission destination such as a cloud server or another external server. In this case, when the scanner of the MFP 100 is being used or when trouble occurs in the scanner, it is difficult to use the above-mentioned function of the server 200. Therefore, it is preferable to display state information related to the scanner, such as the usage state of the scanner, scanner trouble, and scanner jam, in the specific area 213 (213a and 213b).

In addition, the server 200 has, as another function, a direct print function which converts print target data downloaded from a cloud server or another server into a file format, transmits the print target data to the MFP 100, and directs the MFP 100 to print the print target data using the print function of the MFP 100. In a case where this function is used, when the print function of the MFP 100 is being used or when trouble occurs in the print function, it is difficult to use the print function. Therefore, it is preferable to display state information related to printing, such as the usage state of a print engine of the MFP 100, print engine trouble, and printer jam, in the specific area 213 (213a and 213b).

As such, for example, in order to display the state information related to the scanner of the MFP 100 or the state information related to printing, the drawing controller 203 of the server 200 selects state information related to the function that is currently being performed or is to be performed by an application from the state information illustrated in FIG. 10 or FIG. 12 during initial setting control and preferentially displays the selected state information in the specific area 213 (213a and 213b).

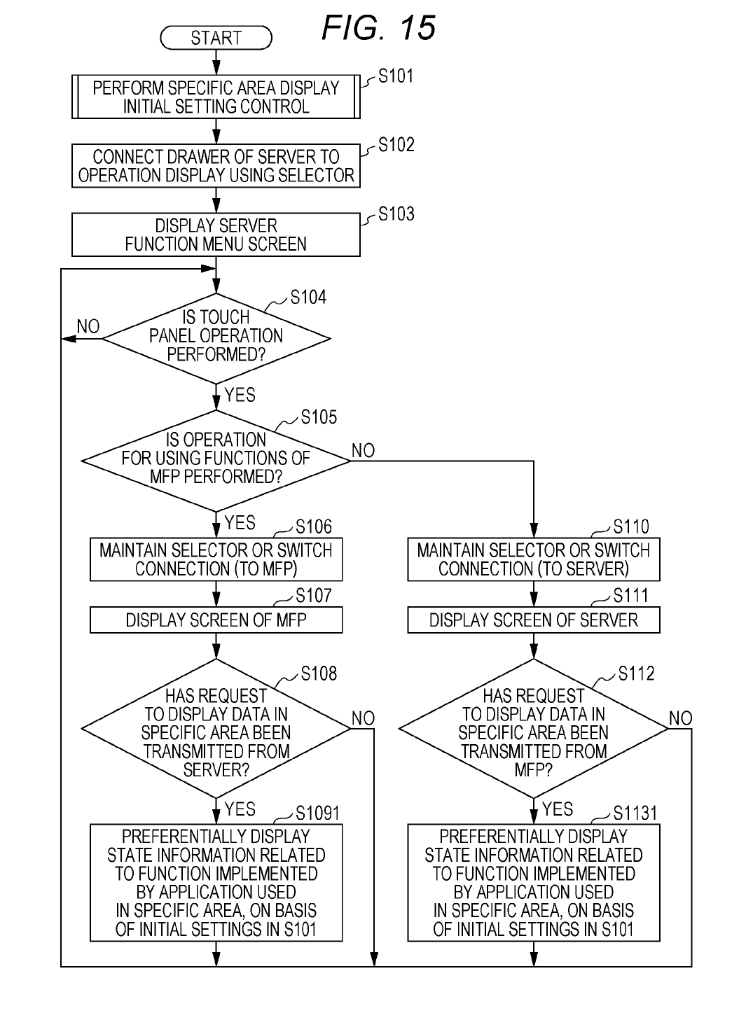

FIG. 15 is a flowchart illustrating the operation of the information processing apparatus 10 in a case where the state information of the opponent device related to the function that is currently being performed or is to be performed is preferentially displayed in the specific area 113 (113a and 113b) or 213 (213a and 213b).

In FIG. 15, steps S101 to step S108 and step S110 to step S112 are the same as those in the flowchart illustrated in FIG. 7. Therefore, these steps are denoted by the same step numbers and the detailed description thereof will not be repeated.

In step S108, the system controller 101 of the MFP 100 determines whether a request to display data in the specific area 113 (113a and 113b) on the screen has been transmitted from the server 200. In a case where the request has not been transmitted (NO in step S108), the system controller 101 returns to step S104 and determines whether the next operation has been performed for the touch panel. In a case where the request to display data in the specific area 113 (113a and 113b) has been transmitted (YES in step S108), in step S1091, the drawing controller 103 of the MFP 100 displays the state information, which is related to the function implemented by the application that is being used and has been transmitted from the server 200, in the specific area 113 (113a and 113b) on the basis of the initial settings obtained in step S101 and returns to step S104.

In a case where the touch panel operation is not an operation for using the functions of the MFP 100 in step S105 (NO in step S105), since the touch panel operation is an operation for using the functions of the server 200, the switching controller 20 maintains or switches the connection between the operation display 300 and the drawing controller 203 of the server 200 by the selector 30 in step S110. In step S111, the drawing controller 203 of the server 200 displays the generated next display data on the operation display 300.

In step S112, the system controller 201 of the server 200 determines whether a request to display data in the specific area 213 (213a and 213b) on the screen has been transmitted from the MFP 100. In a case where the request has not been transmitted (NO in step S112), the system controller 201 returns to step S104 and determines whether the next operation has been performed for the touch panel. In a case where the request to display data in the specific area 213 (213a and 213b) has been transmitted (YES in step S112), in step S1131, the drawing controller 203 of the server 200 displays the state information, which is related to the function implemented by the application that is being used and has been transmitted from the MFP 100, in the specific area 213 (213a and 213b) on the basis of the initial settings obtained in step S101 and returns to step S104.

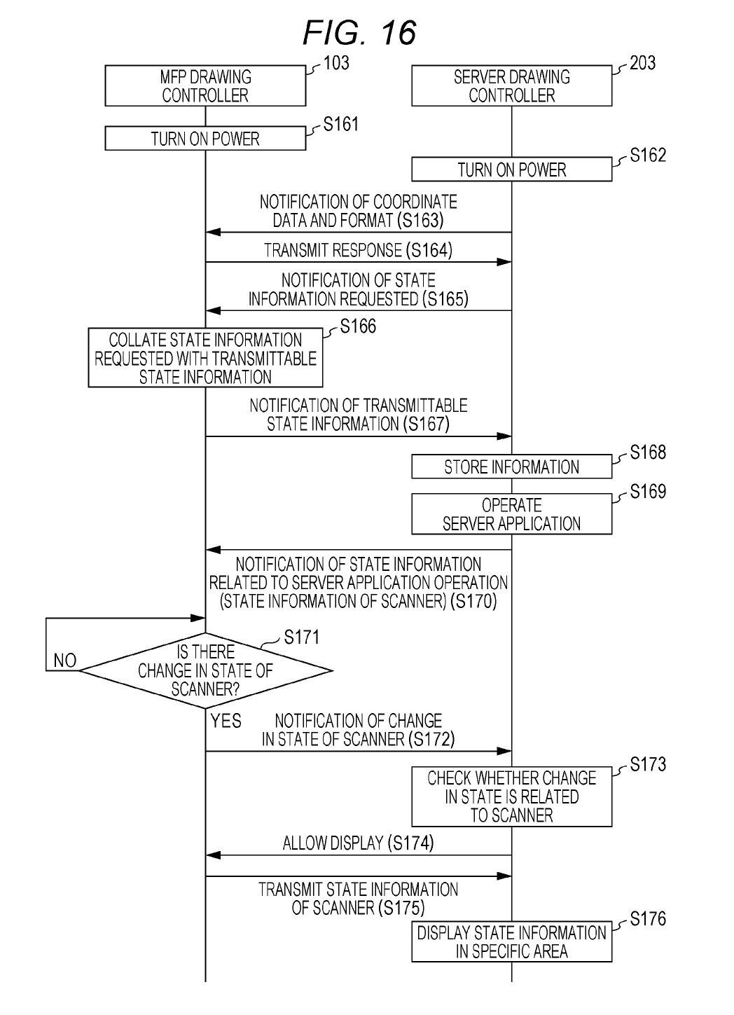

FIG. 16 is a sequence diagram illustrating the operation of each of the drawing controllers 203 and 103 until the state information, which has been transmitted from the MFP 100 and is related to the function that is being performed, is displayed in the specific area 213 (213a and 213b) of the server 200 after notification of coordinate data, a data format, and the state information requested to be transmitted is provided from the drawing controller 203 of the server 200 to the drawing controller 103 of the MFP 100 in a case where the information processing apparatus 10 performs the operation illustrated in FIG. 15.

When the MFP 100 and the server 200 are turned on in step S161 and step S162, the drawing controller 203 of the server 200 extracts the coordinate data of the specific area 213 (213a and 213b) associated with the initial screen of the server 200 and the data format of the state information displayed in the specific area 213 (213a and 213b) and notifies the drawing controller 103 of the MFP 100 of the extracted information (step S163). When recognizing the received coordinate data and data format, the drawing controller 103 of the MFP 100 transmits a response indicating that the coordinate data and the data format have been recognized (step S164).

Then, the drawing controller 203 of the server 200 notifies the drawing controller 103 of the MFP 100 of the state information of the MFP 100 requested to be transmitted (step S165).

When receiving the state information, the drawing controller 103 of the MFP 100 detects the state information stored therein from the entire state information requested to be transmitted and checks whether the state information can be transmitted (step S166). Then, the drawing controller 103 notifies the drawing controller 203 of the server 200 of the transmittable state information in addition to information such as information indicating whether the provided image is used, the data format, and the specific area in which the state information is displayed (step S167). The drawing controller 203 of the server 200 stores the received information in the storage (step S168).

Then, when the user operates an application for implementing the function of the server 200 (step S169), the drawing controller 203 of the server 200 extracts state information related to the function implemented by the operated application from the state information that can be transmitted by the MFP 100 notification of which has been provided from the MFP 100 and notifies the drawing controller 103 of the MFP 100 of the extracted state information (step S170). For example, in a case where the function of the server 200 implemented by the application is a function that uploads scan data to a cloud server or another server, using the scanner of the MFP 100, the drawing controller 203 notifies the MFP 100 of the state information related to the scanner.

For example, in a case where the application operated in step S169 is an application that needs to be operatively associated with an external server, such as an application that stores scan data read by the scanner of the MFP 100 in the external server or an application that instructs the MFP 100 to directly print the print data stored in the external server, after the application is operated, the server 200 may notify the external server that the application has been operated. After the server 200 is allowed to operate by the external server that can operate, in step S170, the server 200 may extract the state information related to the function implemented by the operated application and may notify the MFP 100 of the extracted state information.

Then, the drawing controller 103 of the MFP 100 monitors whether there is a change in the state of the scanner on the basis of the state information notification of which is provided (step S171). In a case where there is a change in the state (YES in step S171), the drawing controller 103 notifies the drawing controller 203 of the server 200 that there is a change in the state and requests the display of the state information (step S172).

The drawing controller 203 of the server 200 checks whether the change in the state is a change in state related to the state information of the scanner which has been transmitted as the transmittable state information from the MFP 100 in advance and then stored in the storage (step S173). In a case where the changes in state correspond to each other, the drawing controller 203 notifies the drawing controller 103 of the MFP 100 that display has been allowed (step S174).

When receiving the display allowance notification, the drawing controller 103 of the MFP 100 transmits the corresponding state information of the scanner to the drawing controller 203 of the server 200 (step S175). The drawing controller 203 of the server 200 displays the received state information in the specific area 213 (213a and 213b) (step S176).

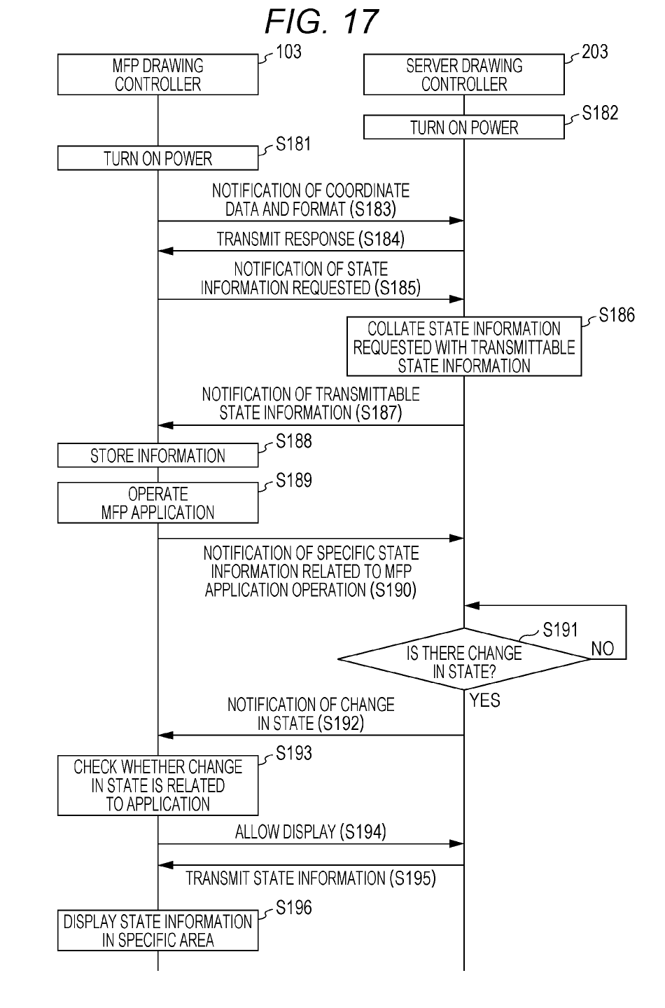

FIG. 17 is a sequence diagram illustrating the operation of each of the drawing controllers 203 and 103 until the state information, which has been transmitted from the server 200 and is related to the function that is being performed, is displayed in the specific area 113 (113a and 113b) of the MFP 100 after notification of coordinate data, a data format, and the state information requested to be transmitted is provided from the drawing controller 103 of the MFP 100 to the drawing controller 203 of the server 200 in a case where the information processing apparatus 10 performs the operation illustrated in FIG. 15.

When the MFP 100 and the server 200 are turned on in step S181 and step S182, the drawing controller 103 of the MFP 100 extracts the coordinate data of the specific area 113 (113a and 113b) associated with the initial screen of the MFP 100 and the data format of the state information displayed in the specific area 113 (113a and 113b) and notifies the drawing controller 203 of the server 200 of the extracted information (step S183). When recognizing the received coordinate data and data format, the drawing controller 203 of the server 200 transmits a response indicating that the coordinate data and the data format have been recognized (step S184).

Then, the drawing controller 103 of the MFP 100 notifies the drawing controller 203 of the server 200 of the state information of the server 200 requested to be transmitted (step S185).

When receiving the state information, the drawing controller 203 of the server 200 detects the state information stored therein from the entire state information requested to be transmitted and checks whether an image (display data) can be transmitted (step S186). Then, the drawing controller 203 notifies the drawing controller 103 of the MFP 100 of the transmittable state information in addition to information such as information indicating whether the provided image is used, the data format, and the specific area in which the state information is displayed (step S187). The drawing controller 103 of the MFP 100 stores the received information in the storage (step S188).

Then, when the user operates an application for implementing the function of the MFP 100 (step S189), the drawing controller 103 of the MFP 100 extracts state information related to the function implemented by the operated application from the state information that can be transmitted by the server 200 notification of which has been provided from the server 200 and notifies the drawing controller 203 of the server 200 of the extracted state information (step S190).

In a case where the application operated in step S189 is an application that needs to be operatively associated with an external server, after the application is operated, the MFP 100 may notify the external server that the application has been operated. After the MFP 100 is allowed to operate by the external server that can operate, in step S190, the MFP 100 may extract the state information related to the function implemented by the operated application and may notify the server 200 of the extracted state information.

Then, the drawing controller 203 of the server 200 monitors whether there is a change in state related to the state information notification of which is provided (step S191). In a case where there is a change in state (YES in step S191), the drawing controller 203 notifies the drawing controller 103 of the MFP 100 that there is a change in state and requests the display of the state information (step S192).

The drawing controller 103 of the MFP 100 checks whether the change in state is a change in state related to the state information which has been transmitted as the transmittable state information from the server 200 in advance and then stored in the storage (step S193). In a case where the changes in state correspond to each other, the drawing controller 103 notifies the drawing controller 203 of the server 200 that display has been allowed (step S194).

When receiving the display allowance notification, the drawing controller 203 of the server 200 transmits the corresponding state information to the drawing controller 103 of the MFP 100 (step S195). The drawing controller 103 of the MFP 100 displays the received display data in the specific area 113 (113a and 113b) (step S196).

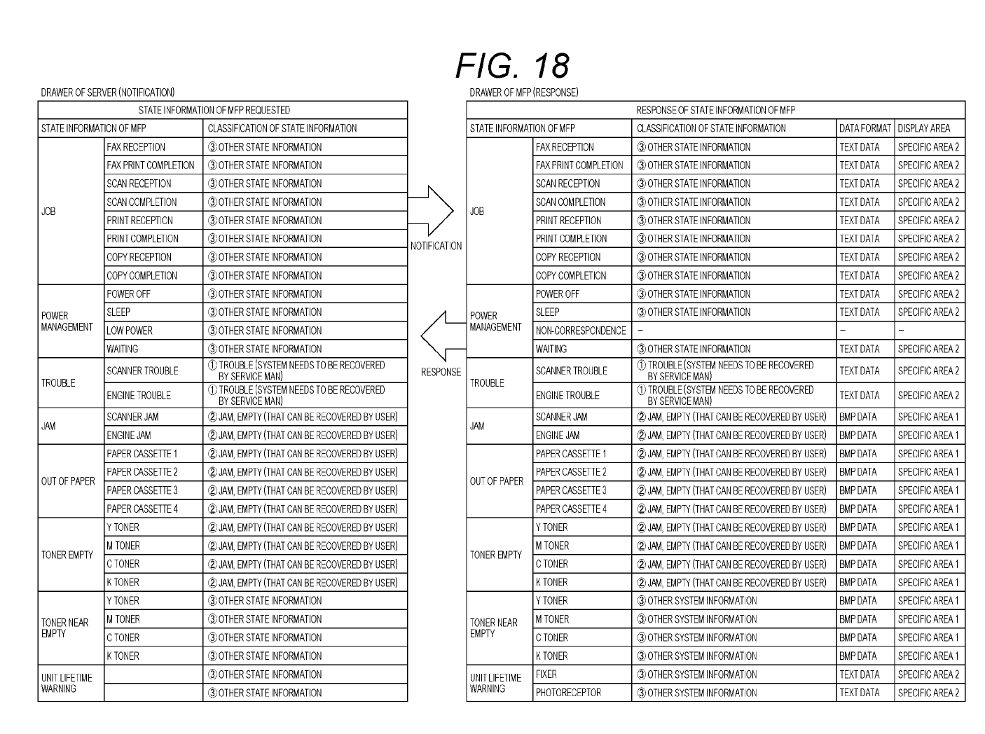

FIGS. 18 to 21 are diagrams illustrating another example of the operation of the information processing apparatus 10. In this example of the operation, the state information is classified into a plurality of groups and priority is given to each group.

For example, the state information of the MFP 100 illustrated in FIG. 18 requested to be transmitted from the server 200 to the MFP 100 is classified into three state information items, that is, trouble or error which needs to be recovered by a service man and is represented by circled number 1, trouble or error which can be recovered by the user and is represented by circled number 2, and other state information represented by circled number 3. The state information represented by circled number 1 has the highest display priority, followed by the state information represented by circled number 2 and the state information represented by circled number 3. Therefore, in a case where a plurality of state changes occur in the MFP 100 and it is necessary to display two or more state information items belonging to different classifications, the state information to be displayed in the specific area 213 (213a and 213b) of the server 200 is determined on the basis of the priority.

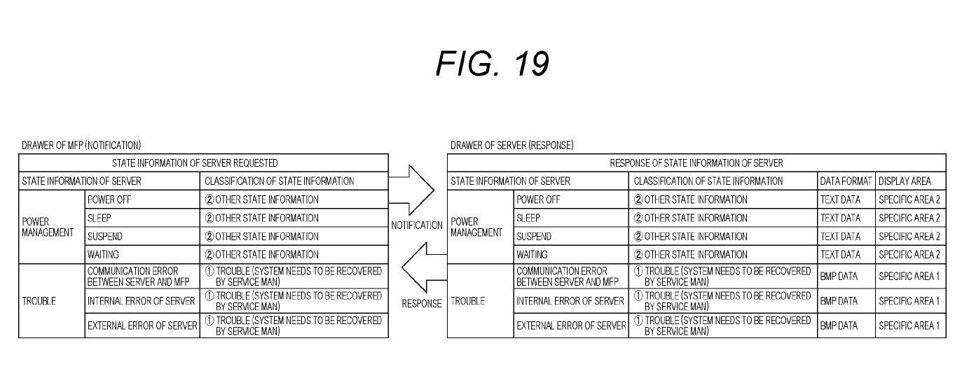

In contrast, the state information of the server 200 illustrated in FIG. 19 requested to be transmitted from the MFP 100 to the server 200 is classified into two state information items, that is, trouble or error which needs to be recovered by a service man and is represented by circled number 1 and other state information represented by circled number 2. The state information represented by circled number 1 has the highest display priority, followed by the state information represented by circled number 2. Therefore, in a case where a plurality of state changes occur in the server 200 and it is necessary to display two or more state information items belonging to different classifications, the state information to be displayed in the specific area 113 (113a and 113b) of the MFP 100 is determined on the basis of the priority.

As such, in a case where there are a plurality of state information items to be displayed, the state information to be displayed is determined on the basis of priority. Therefore, it is possible to preferentially display state information required rapidly by the user.

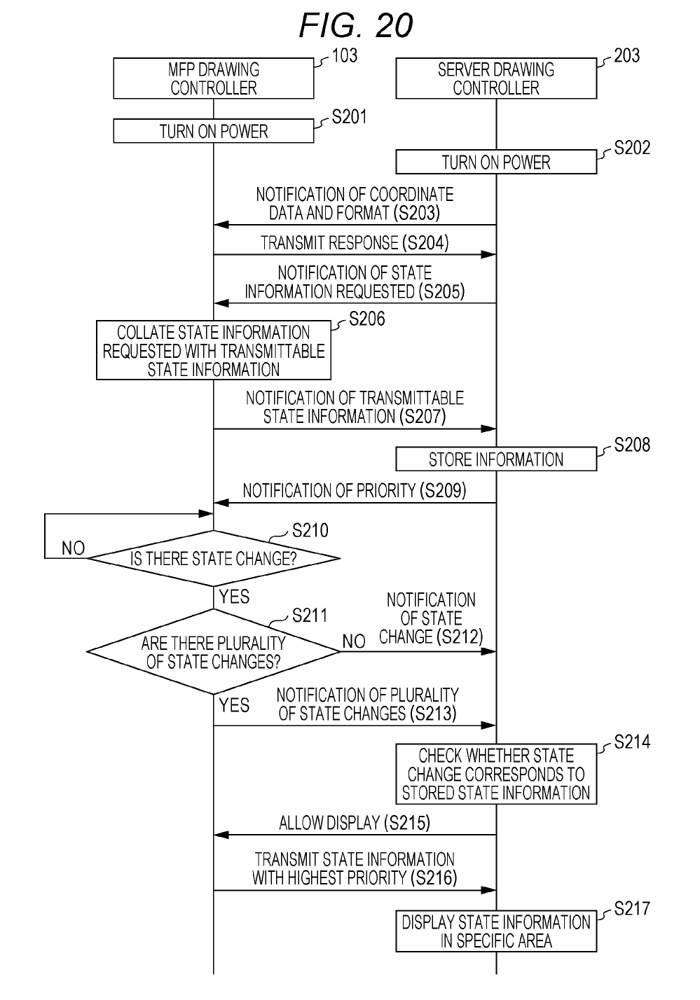

FIG. 20 is a sequence diagram illustrating the operation of each of the drawing controllers 203 and 103 until the state information transmitted from the MFP 100 is displayed in the specific area 213 (213a and 213b) of the server 200 after notification of coordinate data, a data format, and the state information requested to be transmitted is provided from the drawing controller 203 of the server 200 to the drawing controller 103 of the MFP 100 in a case where priority is set to the state information.

When the MFP 100 and the server 200 are turned on in step S201 and step S202, the drawing controller 203 of the server 200 extracts the coordinate data of the specific area 213 (213a and 213b) associated with the initial screen of the server 200 and the data format of the state information displayed in the specific area 213 (213a and 213b) and notifies the drawing controller 103 of the MFP 100 of the extracted information (step S203). When recognizing the received coordinate data and data format, the drawing controller 103 of the MFP 100 transmits a response indicating that the coordinate data and the data format have been recognized (step S204).

Then, the drawing controller 203 of the server 200 notifies the drawing controller 103 of the MFP 100 of the state information of the MFP 100 requested to be transmitted (step S205).

When receiving the state information, the drawing controller 103 of the MFP 100 detects the state information stored therein from the entire state information requested to be transmitted and checks whether the state information can be transmitted (step S206). Then, the drawing controller 103 notifies the drawing controller 203 of the server 200 of the transmittable state information in addition to information such as information indicating whether the provided image is used, the data format, and the specific area in which the state information is displayed (step S207). The drawing controller 203 of the server 200 stores the received information in the storage (step S208).

Then, the drawing controller 203 of the server 200 notifies the drawing controller 103 of the MFP 100 of the predetermined priority of the state information which can be transmitted by the MFP 100 notification of which has been provided from the MFP 100 (step S209).

The drawing controller 103 of the MFP 100 monitors whether a state change has occurred (step S210). In a case where a state change has occurred (YES in step S210), the drawing controller 103 checks whether a plurality of state changes have occurred (step S211). In a case where only one state change has occurred (NO in step S211), the drawing controller 103 notifies the drawing controller 203 of the server 200 that the state change has occurred and requests the display of the state information (step S212). In a case where a plurality of state changes have occurred (YES in step S211), the drawing controller 103 notifies the drawing controller 203 of the server 200 that the plurality of state changes have occurred and requests the display of the state information (step S213).

The drawing controller 203 of the server 200 checks whether the state change is a state change related to the state information which has been transmitted as the transmittable state information from the MFP 100 in advance and then stored in the storage (step S214). In a case where the state change is related to the state information, the drawing controller 203 notifies the drawing controller 103 of the MFP 100 that display has been allowed (step S215).

When receiving the display allowance notification, the drawing controller 103 of the MFP 100 transmits state information with the highest priority to the drawing controller 203 of the server 200 (step S216). In a case where one state change has occurred, the drawing controller 103 transmits one state information item. The drawing controller 203 of the server 200 displays the received state information in the specific area 213 (213a and 213b) (step S217). In a case where a plurality of specific areas are provided, the state information may be transmitted and displayed in descending order of priority. In addition, in a case where the state information items have the same priority, any one of the state information items may be transmitted.

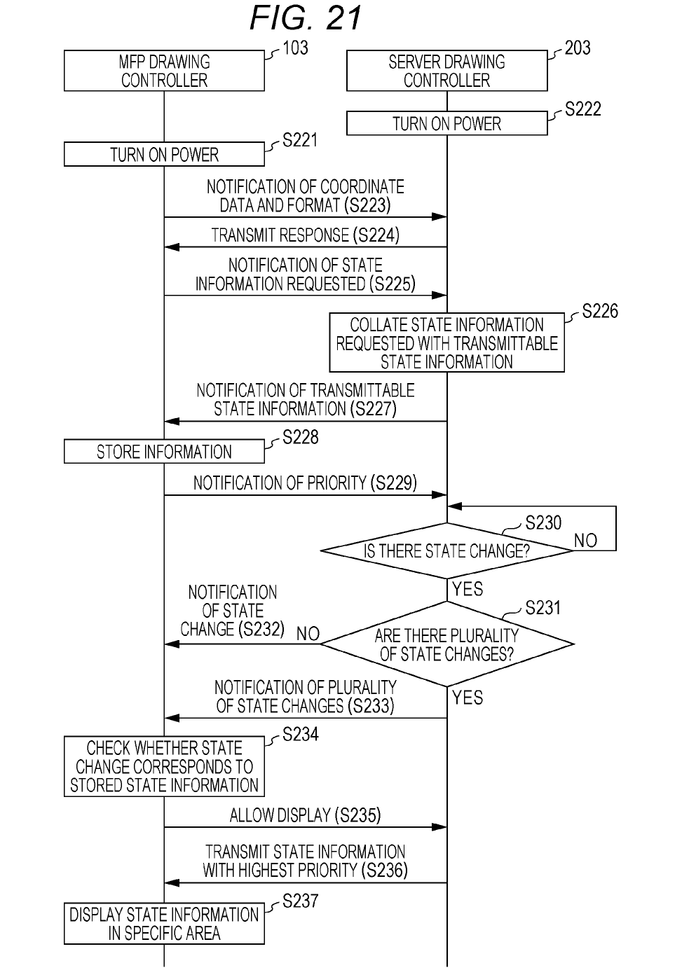

FIG. 21 is a sequence diagram illustrating the operation of each of the drawing controllers 103 and 203 until the state information transmitted from the server 200 is displayed in the specific area 113 (113a and 113b) of the MFP 100 after notification of coordinate data, a data format, and the state information requested to be transmitted is provided from the drawing controller 103 of the MFP 100 to the drawing controller 203 of the server 200 in a case where priority is set to the state information.

When the MFP 100 and the server 200 are turned on in step S221 and step S222, the drawing controller 103 of the MFP 100 extracts the coordinate data of the specific area 113 (113a and 113b) associated with the initial screen of the MFP 100 and the data format of the state information displayed in the specific area 113 (113a and 113b) and notifies the drawing controller 203 of the server 200 of the extracted information (step S223). When recognizing the received coordinate data and data format, the drawing controller 203 of the server 200 transmits a response indicating that the coordinate data and the data format have been recognized (step S224).

Then, the drawing controller 103 of the MFP 100 notifies the drawing controller 203 of the server 200 of the state information of the server 200 requested to be transmitted (step S225).

When receiving the state information, the drawing controller 203 of the server 200 detects the state information stored therein from the entire state information requested to be transmitted and checks whether the state information can be transmitted (step S226). Then, the drawing controller 203 notifies the drawing controller 103 of the MFP 100 of the transmittable state information in addition to information such as information indicating whether the provided image is used, the data format, and the specific area in which the state information is displayed (step S227). The drawing controller 103 of the MFP 100 stores the received information in the storage (step S228).

Then, the drawing controller 103 of the MFP 100 notifies the drawing controller 203 of the server 200 of the predetermined priority of the state information which can be transmitted by the server 200 notification of which has been provided from the server 200 (step S229).

The drawing controller 203 of the server 200 monitors whether a state change has occurred (step S230). In a case where a state change has occurred (YES in step S230), the drawing controller 203 checks whether a plurality of state changes have occurred (step S231). In a case where only one state change has occurred (NO in step S231), the drawing controller 203 notifies the drawing controller 103 of the MFP 100 that the state change has occurred and requests the display of the state information (step S232). In a case where a plurality of state changes have occurred (YES in step S231), the drawing controller 203 notifies the drawing controller 103 of the MFP 100 that the plurality of state changes have occurred and requests the display of the state information (step S233).

The drawing controller 103 of the MFP 100 checks whether the state change is a state change related to the state information which has been transmitted as the transmittable state information from the server 200 in advance and then stored in the storage (step S234). In a case where the state change is related to the state information, the drawing controller 103 notifies the drawing controller 203 of the server 200 that display has been allowed (step S235).

When receiving the display allowance notification, the drawing controller 203 of the server 200 transmits state information with the highest priority to the drawing controller 103 of the MFP 100 (step S236). In a case where one state change has occurred, the drawing controller 203 transmits one state information item. The drawing controller 103 of the MFP 100 displays the received state information in the specific area 113 (113a and 113b) (step S237). In a case where a plurality of specific areas are provided, the state information may be transmitted and displayed in descending order of priority. In addition, in a case where the state information items have the same priority, any one of the state information items may be transmitted.

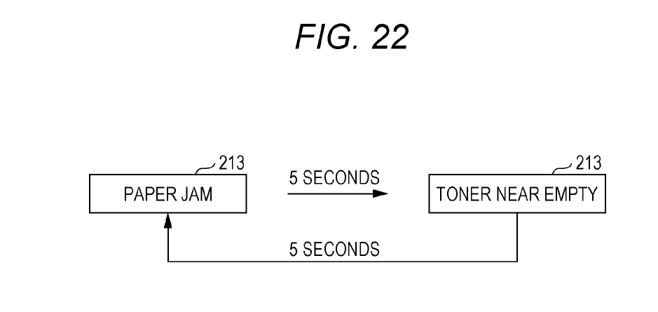

In the embodiment illustrated in FIGS. 18 to 21, priority is set to state information. In a case where a plurality of state information items compete with each other in display, state information with the highest priority is displayed. However, in a case where a plurality of state information items compete with each other in display, the plurality of state information items may be sequentially displayed in the specific area 113 (113a and 113b) or 213 (213a and 213b) so as to be switched at a predetermined interval, as illustrated in FIG. 22. In the example illustrated in FIG. 22, two state information items of the MFP 100, that is, paper jam and toner near empty are sequentially displayed in one specific area 213 of the server 200 so as to be switched at an interval of 5 seconds.

As such, since a plurality of state information items are sequentially displayed in a specific area so as to be switched, the user can sequentially check the plurality of state information items.

According to an embodiment of the invention, with the first aspect of the invention, the information processing apparatus includes the image processing device, the server that is connected to the image processing device, and the operation display that is shared by the image processing device and the server. A display screen that is displayed on the operation display on the basis of the display data of one of the image processing device and the server includes at least one specific area for displaying state information indicating the state of the other device. The drawing controller of one of the image processing device and the server displays the display data stored in the display memory of the host device on the operation display in a case where the drawing controller is connected to the operation display and changes the display data such that the state information is displayed in the specific area while being connected to the operation display in a case where the state information is acquired from the other device. Therefore, in a case where the screen of one of the image processing device or the server is displayed on the operation display and there is a change in the state of the other device, the user can recognize the change in the state of the other device from the state information displayed in the specific area, without switching the displayed screen to the screen of the other device. As a result, it is possible to improve operability.

According to the second aspect of the invention, the drawing controller of one of the image processing device and the server notifies the other device of coordinate data of the specific area and state information requested to be transmitted in advance, and the other device transmits its own state information to the one device on the basis of the information. Therefore, it is possible to accurately display the state information of the other device in the specific area.

According to the third aspect of the invention, the user can recognize a state related to at least one of the reception and completion of a job, a power transition state, paper jam, trouble, out of paper, and an error in the image processing device while displaying the screen of the server. In addition, the user can recognize a state related to at least one of a power transition state, trouble, and an error in the server while displaying the screen of the image processing device.

According to the fourth aspect of the invention, text data or bitmap data is set in advance as the data format of the display data displayed in the specific area of the one device, and the other device transmits state information suitable for the data format or transmits, as the state information, code data that is given to the display data of the state information provided in the one device. Therefore, it is possible to accurately display the state information transmitted from the other device in the specific area of the one device.

According to the fifth aspect of the invention, when power is turned on, the drawing controller of the server can check whether the state information of the image processing device requested by the server can be displayed in the specific area. Therefore, in a case where there is a change in the state of the image processing device when the function of the server operates, it is possible to reliably display state information corresponding to the change in state in the specific area.

According to the sixth aspect of the invention, when power is turned on, the drawing controller of the image processing device can check whether the state information of the server requested by the image processing device can be displayed in the specific area. Therefore, in a case where there is a change in the state of the server when the function of the image processing device operates, it is possible to reliably display state information corresponding to the change in state in the specific area.

According to the seventh aspect of the invention, the state information displayed in the specific area is classified into (1) trouble or error that needs to be recovered by a service man, (2) trouble or error that is capable of being recovered by a user, and (3) others. In a case where there are a plurality of state information items to be displayed, (1) has the highest priority in display, followed by (2) and (3). Therefore, it is possible to preferentially display state information required rapidly by the user.

According to the eighth aspect of the invention, the switching controller connects the operation display and the drawing controller of the server. In a case where the server performs a function that directs the image processing device to scan a document with a scanner, receives scan data from the image processing device, and transmits the received scan data to an external transmission destination, the state information of the image processing device related to the function that is performed is displayed in the specific area of the server. Therefore, the user can recognize the state of the image processing device related to the function that is performed by an instruction from the user.

According to the ninth aspect of the invention, the switching controller connects the operation display and the drawing controller of the server. In a case where the server performs a function that receives print target data from the outside, transmits the received print target data to the image processing device, and directs the image processing device to print the print target data, the state information of the image processing device related to the function that is performed is displayed in the specific area of the server. Therefore, the user can recognize the state of the image processing device related to the function that is performed by an instruction from the user.

According to the tenth aspect of the invention, a plurality of state information items to be displayed in the specific area are sequentially displayed while being switched. Therefore, the user can sequentially check a plurality of state information items.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing apparatus comprising:
an image processing device;
a server that is connected to the image processing device; and
an operation display that is shared by the image processing device and the server,
wherein each of the image processing device and the server includes:
a display memory that stores display data displayed on the operation display;
a drawing controller that performs control for displaying the display data stored in the display memory on the operation display; and
a state information transmitter that is capable of transmitting state information indicating a state of a host device to the other device,
the information processing apparatus further includes a switching controller that switches connection between the operation display and the drawing controller of the image processing device or the server,
a display screen that is displayed on the operation display on the basis of the display data of one of the image processing device and the server includes at least one specific area for displaying the state information, and
the drawing controller of one of the image processing device and the server displays the display data stored in the display memory of the host device on the operation display in a case where the drawing controller is connected to the operation display and changes the display data such that the state information is displayed in the specific area while being connected to the operation display in a case where the state information is acquired from the other device.

2. The information processing apparatus according to claim 1,
wherein the drawing controller of one of the image processing device and the server notifies the other device of coordinate data of the specific area and state information requested to be transmitted in advance, and
the other device transmits its own state information to the one device on the basis of the information.

3. The information processing apparatus according to claim 1,
wherein the state information of the image processing device displayed in the specific area of the server is information related to at least one of reception and completion of a job, a power transition state, paper jam, trouble, out of paper, and an error, and
the state information of the server displayed in the specific area of the image processing device is information related to at least one of a power transition state, trouble, and an error.

4. The information processing apparatus according to claim 1,
wherein text data or bitmap data is set in advance as a data format of the display data displayed in the specific area of the one device, and
the other device transmits state information suitable for the data format or transmits, as the state information, code data that is given to display data of the state information provided in the one device.

5. The information processing apparatus according to claim 1,
wherein, when power is turned on, the drawing controller of the server notifies the image processing device of coordinate data of the specific area, a data format of the state information displayed in the specific area, and state information requested to be transmitted,
the image processing device notifies the server whether each of the state information items notification of which is provided is capable of being transmitted,
when a function of the server is operated, the drawing controller of the server selects necessary state information of the image processing device from the state information that is capable of being transmitted by the image processing device and requests the selected state information from the image processing device,
in a case where a state change corresponding to the requested state information occurs in the image processing device, the image processing device transmits the corresponding state information to the server, and
the drawing controller of the server displays the transmitted state information in the specific area.

6. The information processing apparatus according to claim 1,
wherein, when power is turned on, the drawing controller of the image processing device notifies the server of coordinate data of the specific area, a data format of the state information displayed in the specific area, and state information requested to be transmitted,
the server notifies the image processing device whether each of the state information items notification of which is provided is capable of being transmitted,
when a function of the image processing device is operated, the drawing controller of the image processing device selects necessary state information of the server from the state information that is capable of being transmitted by the server and requests the selected state information from the server,
in a case where a state change corresponding to the requested state information occurs in the server, the server transmits the corresponding state information to the image processing device, and
the drawing controller of the image processing device displays the transmitted state information in the specific area.

7. The information processing apparatus according to claim 1,
wherein the state information displayed in the specific area is classified into (1) trouble or error that needs to be recovered by a service man, (2) trouble or error that is capable of being recovered by a user, (3) others, and
in a case where there are a plurality of state information items to be displayed, (1) has the highest priority in display, followed by (2) and (3).

8. The information processing apparatus according to claim 1,
wherein the switching controller connects the operation display and the drawing controller of the server, and
in a case where the server performs a function that directs the image processing device to scan a document with a scanner, receives scan data from the image processing device, and transmits the received scan data to an external transmission destination, the drawing controller of the server displays the state information of the image processing device related to the function in the specific area.

9. The information processing apparatus according to claim 1,
wherein the switching controller connects the operation display and the drawing controller of the server, and
in a case where the server performs a function that receives print target data from the outside, transmits the received print target data to the image processing device, and directs the image processing device to print the print target data, the drawing controller of the server displays the state information of the image processing device related to the function in the specific area.

10. The information processing apparatus according to claim 1,
wherein, in a case where there are a plurality of state information items to be displayed in the specific area, the drawing controller of the server sequentially displays the plurality of state information items in the specific area while switching plurality of state information items.
